(19) United States
(12) Patent Application Publication
(10) Pub. No.: US 2010/0264226 A1
(43) Pub. Date: Oct. 21, 2010

(54) PAYMENT CARD HAVING ACCEPTANCE ATTRIBUTES ON A SINGLE SIDE

(75) Inventors: Margaret Loughran, Patterson, NY (US); James Carrington, Larchmont, NY (US); Edward Olebe, New York, NY (US); Charles Breuel, Briarcliff Manor, NY (US); Charles Unger, Dobbs Ferry, NY (US)

Correspondence Address: RYAN, MASON & LEWIS, LLP, 1300 POST ROAD, SUITE 205, FAIRFIELD, CT, 06824, US

(73) Assignee: MasterCard International, Incorporated, Purchase, NY (US)

(21) Appl. No.: 12/708,029

(22) Filed: Feb. 18, 2010

Related U.S. Application Data
(60) Provisional application No. 61/153,693, filed on Feb. 19, 2009.

(51) Int. Cl. G06K 19/077; G06K 19/06; G06K 19/00

(52) U.S. Cl. 235/492; 235/493; 235/494; 235/487

(57) ABSTRACT

A payment card has a generally planar body having a first side and a second side, and a plurality of acceptance attributes on the second side. The first side is formed without any acceptance attributes thereon. The first side may include artwork of an issuer of the payment card. The acceptance attributes may include, for example, a signature panel, a cardholder name, a card expiration date, at least one of a bar code and a magnetic stripe, and a card security code. A method of using such a card includes physically presenting the card to a merchant, and viewing, by the merchant, of at least needed ones of the acceptance attributes without the merchant being required to turn the card over. Another method of using such a card includes supplying (without necessarily physically presenting the card), from a card user to a merchant, acceptance attribute information of a payment card of the kind described, as well as viewing, by the card user, of the acceptance attribute information without the card user being required to turn the card over.

### CROSS-REFERENCE TO RELATED APPLICATION(S)

This application claims the benefit of U.S. Provisional Application Ser. No. 61/153,693, filed on Feb. 19, 2009, the complete disclosure of which is expressly incorporated herein by reference in its entirety for all purposes.

### FIELD OF THE INVENTION

The present invention relates generally to electronic commerce, and, more particularly, to payment cards for use with electronic payment systems.

### BACKGROUND OF THE INVENTION

A payment card is a card that can be presented by the cardholder to make a payment. By way of example, and without limiting the generality of the foregoing, a payment card can be a credit card, debit card, charge card, stored-value card, or prepaid card.

Generally, all payment cards have a “front” and a “back.” In the case of a store card (also known as a private label or closed-loop card), the card front usually has the store name and/or logo and at least an account number and customer name, and the card back usually has at least a bar code or a magnetic stripe that contains account information. In the case of a general-purpose payment card (also known as an open-loop card), such as a MasterCard card, the card front generally has the payment brand, an issuer brand, an account number, cardholder name, expiration date, and certain security features (such as a hologram). The card back generally has at least a magnetic stripe and signature panel.

### SUMMARY OF THE INVENTION

Principles of the present invention provide techniques for a payment card having acceptance attributes on a single side.

In one aspect, an exemplary embodiment of a payment card includes a generally planar body having a first side and a second side, and a plurality of acceptance attributes on the second side, wherein the first side is formed without any acceptance attributes thereon. The first side may include artwork of an issuer of the payment card. The acceptance attributes may include, for example, a signature panel, a cardholder name, a card expiration date, at least one of a bar code and a magnetic stripe, and a card security code.

In another aspect, an exemplary method of using a payment card includes physically presenting, to a merchant, a payment card of the kind described, and viewing by the merchant, of at least needed ones of the acceptance attributes without the merchant being required to turn the card over. Additional steps can include conducting a transaction based on the merchant viewing of needed ones of the acceptance attributes, and/or promoting an issuer of the card by including issuer artwork on the first side of the card.

In still another aspect, another exemplary method of using a payment card includes supplying (without necessarily physically presenting the card), from a card user to a merchant, acceptance attribute information of a payment card of the kind described. The above-described plurality of acceptance attributes include acceptance attribute information (for example, account number and card security code). An additional step includes viewing, by the card user, of the acceptance attribute information without the card user being required to turn the card over. Additional steps can include conducting a transaction based on the supplied acceptance attribute information, and/or promoting an issuer of the card by including issuer artwork on the first side of the card.

These and other features and advantages of the present invention will become apparent from the following detailed description of illustrative embodiments thereof, which is to be read in connection with the accompanying drawings.

### BRIEF DESCRIPTION OF THE DRAWINGS

FIGS. 1A and 1B illustrate a preferred embodiment, according to an aspect of the invention;

FIGS. 2A and 2B illustrate another preferred embodiment, according to another aspect of the invention;

FIG. 3 shows a general example of a payment system that can implement techniques of the invention;

FIG. 4 depicts an exemplary inter-relationship between and among: (i) a payment network configured to facilitate transactions between multiple issuers and multiple acquirers, (ii) a plurality of customers, (iii) a plurality of merchants, (iv) a plurality of acquirers, and (v) a plurality of issuers;

FIG. 5 is a block diagram of an exemplary computer system useful, in at least some cases, in connection with one or more embodiments of the invention;

FIGS. 6A and 6B illustrate yet another preferred embodiment, according to yet another aspect of the invention (with contact plate for chip); and

FIGS. 7A and 7B illustrate still another preferred embodiment, according to still another aspect of the invention (with indicia of contactless operation).

### DETAILED DESCRIPTION OF PREFERRED EMBODIMENTS

As noted above, a payment card is a card that can be presented by the cardholder to make a payment. By way of example, and without limiting the generality of the foregoing, a payment card can be a credit card, debit card, charge card, stored-value card, or prepaid card.

Generally, all payment cards have a “front” and a “back.” In the case of a store card (also known as a private label or closed-loop card), the card front usually has the store name and/or logo and at least an account number and customer name, and the card back usually has at least a bar code or a magnetic stripe that contains account information. In the case of a general-purpose payment card (also known as an open-loop card), such as a MasterCard card, the card front generally has the payment brand, an issuer brand, an account number, cardholder name, expiration date, and certain security features (such as a hologram). The card back generally has at least a magnetic stripe and signature panel.

Generally, the issuer of a payment card must work around the foregoing elements on the front or back of a card to present visually appealing card artwork to the cardholder.

Embodiments of the invention provide a payment card in which all acceptance attributes or features are located on one side of the card. Acceptance attributes are those attributes that are required by a merchant to accept the card for payment and/or to process a transaction. Such acceptance attributes include: signature panel, cardholder name, expiration date, magnetic stripe, and required security features (such as hologram, ultraviolet ink, and CVC2 code (or other card security code).

By way of background, the Card Security Code (CSC), sometimes called Card Verification Value (CVV or CV2), Card Verification Value Code (CVVC), Card Verification Code (CVC), Verification Code (V-Code or V Code), or Card Code Verification (CCV) is a security feature for credit or debit card transactions, giving increased protection against credit card fraud. There are several types of security codes:
The first code, called CVC1 or CVV1, is encoded on the magnetic stripe of the card and used for transactions in person.
The second code, and the most cited, is CVV2 or CVC2. This CSC (also known as a CCID or Credit Card ID) is often asked for by merchants for them to secure “card not present” transactions occurring over the Internet, by mail, fax or over the phone. In many countries in Western Europe, due to increased attempts at card fraud, it is now mandatory to provide this code when the cardholder is not present in person.
Contactless Card and Chip cards may supply their own codes generated electronically, such as iCVV or Dynamic CVV.

The CVV2 is a 3- or 4-digit value printed on the card or signature strip, but not encoded on the magnetic stripe. MasterCard cards, Visa cards, Diners Club cards, Discover cards, and JCB cards (in each case, including credit and debit cards) have a 3-digit code, called the “CVC2” (card validation code), “CVV2” (card verification value), “CVV,” and “CID” (card identification number), respectively. It is typically not embossed like the card number, and is typically always the final group of numbers printed on the back signature panel of the card. In some applications, the “CVC2” is in a separate panel to the right of the signature strip. This has been done to prevent overwriting of the numbers by signing the card. American Express cards have a 4-digit code printed on the front side of the card above the number, referred to as the CID (or Unique Card Code). It is typically printed flat, not embossed like the card number. The number is typically generated when the card is issued, by hashing the card number and expiration date under a key known only to the issuing bank. Supplying this code in a transaction is intended to verify that the customer has the card in their possession. Knowledge of the code proves that the customer has seen the card, or has seen a record made by somebody who saw the card.

By locating all acceptance attributes on one side of the card, a card according to embodiments of the invention supports:
merchant and cardholder view of all required card acceptance attributes in a central place; and
full use of a card side dedicated to issuer use for non-acceptance card artwork.

One or more embodiments afford the advantage that in interaction with a merchant, there is no need for the merchant to flip the card over. The signature is present on the same side of the card as the other information typically accessed by the merchant (such as account number and expiration date). This reduces the chances for chargeback and/or re-presentment due to the merchant failing to check the signature.

In a preferred but non-limiting embodiment of the invention, the magnetic stripe is provided in a similar color or a shade, tone or tint of the background of the card side on which it is located. In some instances, the magnetic stripe may be the same color as the background; however, this is believed to be less desirable than some other options because it would make the magnetic stripe difficult to locate for swiping purposes (other indicia such as outlines, patterns, or lack of patterns could be used to delineate the magnetic stripe in such a case). Furthermore, in some cases, the magnetic stripe may be in a different, non-coordinated color, or even a conventional black color, but this is believed to be less desirable than some other options because of aesthetic aspects. In a preferred but non-limiting embodiment of the invention, the signature panel and/or the CVC2 area may be presented in the same color, similar color or a shade, tone or tint of the background. If the signature panel and/or the CVC2 area are in the same color as the background, they are preferably delineated therefrom in another manner, such as by having a pattern on the background not present in the signature panel and/or the CVC2 area.

In a preferred but non-limiting embodiment, the signature panel has the name or mark of a payment card network operator, such as MasterCard International Incorporated, imprinted thereon at a 45 degree angle; preferably on a field sympathetic to the background with lettering in a color that is similar to but distinguishable from the field.

The magnetic stripe and/or signature panel are thus preferably color-matched or color-coordinated with and yet subtly distinguishable from the background. Furthermore, in a preferred but non-limiting approach, the two sides of the card are color-matched or color-coordinated with each other.

One or more embodiments create the perception of a card with “two front sides.”

It should be noted that in one or more instances, the operator of a payment card network, such as, by way of example and not limitation, MasterCard International Incorporated or Visa International Service Association, or a private label, may set aesthetic design requirements for one or more payment cards incorporating one or more aspects of the invention.

A magnetic stripe card is a type of card capable of storing data by modifying the magnetism of tiny iron-based magnetic particles on a band of magnetic material on the card. The magnetic stripe, also referred to herein as a mag stripe, is read by physical contact and swiping past a reading head.

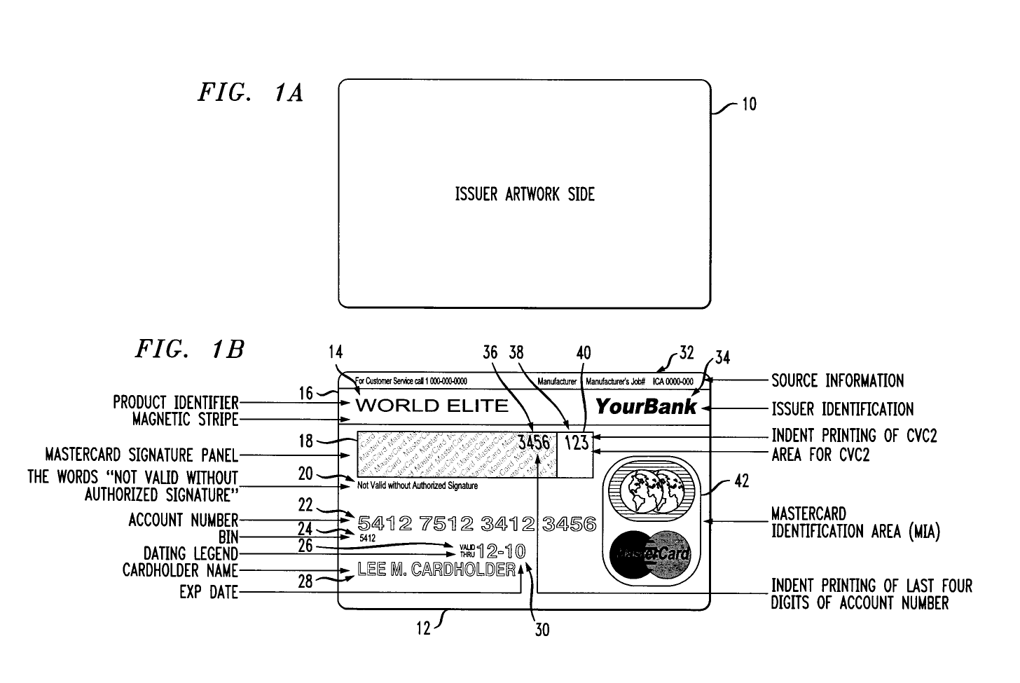

With reference now to FIGS. 1A and 1B, an exemplary embodiment of a payment card includes a first side 10, shown in FIG. 1A, reserved for issuer artwork, and a second side 12, shown in FIG. 1B, on which all the acceptance attributes are located. Viewing legends clockwise from the upper right, the second side includes source information 32, issuer identification 34, indent printing of the CVC2 38, an area for the CVC2 40, a MasterCard identification area (MIA) 42, indent printing of the last four digits of the account number 36, the expiration date 30, cardholder name 28, dating legend (“valid thru”) 26, the BIN (bank identification number) 24, and account number 22. Still continuing the clockwise progression of the legends, also included are the words “not valid without authorized signature,” at 20, a MasterCard signature panel 18, a magnetic stripe 16, and a product identifier 14. It will be seen that the product identifier and issuer identification can be superimposed over the magnetic stripe. Furthermore, the CVC2 panel and signature panel are adjacent. Note that a MasterCard card with a CVC2 security code is shown for exemplary purposes, but other types of cards with other types of card security codes could also be configured in accordance with one or more embodiments of the invention. It should be noted that some cards may not have a product identifier and that some cards may have more, less, or different legends than those shown in the examples. Furthermore, with regard to superimposing the product identifier and/or issuer identification on the magnetic stripe, magnetic stripe material is currently manufactured on a roll and wording, if any, is typically provided thereon in a repetitive pattern. This approach may be taken in some instances, possibly with some kind of indexing scheme; in other cases, an additional decal or the like may be applied over the magnetic stripe; a hologram may be applied (e.g., HOLOMAG®® magnetically encoded strips of JDS UNIPHASE Corporation, 430 North McCarthy Blvd. Milpitas Calif., formerly American Bank Note Holographics, Inc. 2 Applegate Drive, Robbinsville, N.J. 08691) and so on.

MIA 42 and MasterCard signature panel 18 are exemplary and alternatives can be employed for other brands of card.

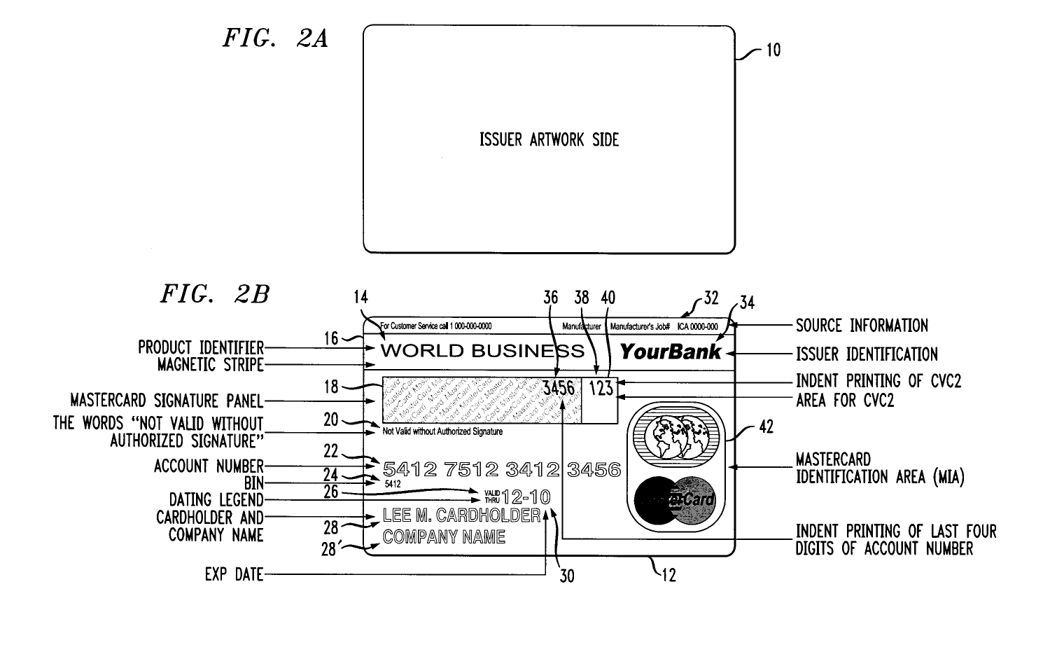

FIGS. 2A and 2B are generally similar to FIGS. 1A and 1B, except that a business card instead of a personal card is shown; the business card has a different product identifier and includes the company name following the cardholder's name as shown at 28′. Otherwise, similar items have received a similar number.

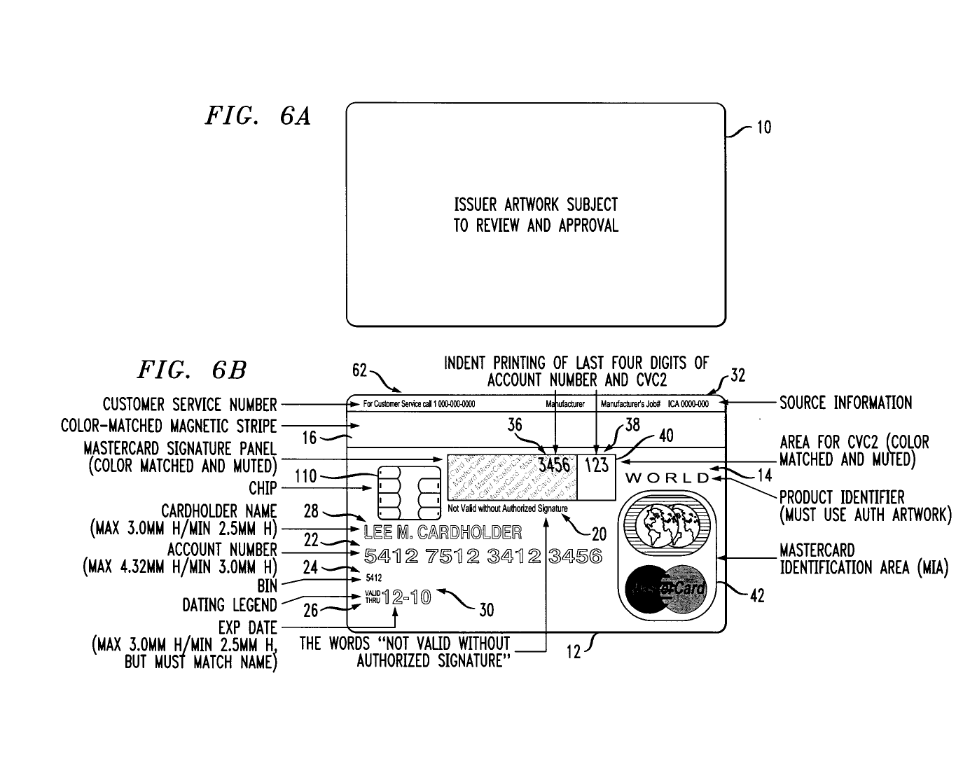

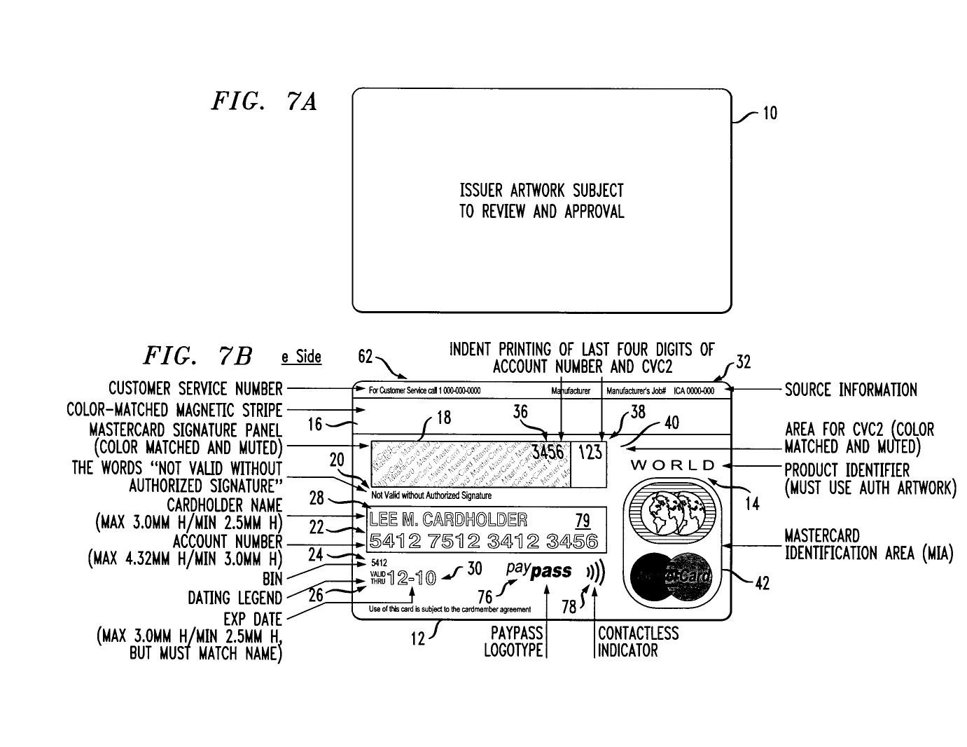

FIGS. 6A and 6B show an alternative embodiment with a chip card having a chip contact plate 110. FIGS. 7A and 7B show an alternative embodiment with indicia 78 indicating that the card is contactless, as well as a corresponding mark 76 (exemplary of a mark for contactless card products and/or services). PAYPASS® is a registered mark of MasterCard International Incorporated of Purchase, N.Y., USA. In these non-limiting examples, there is no printing in magnetic stripe 16; the product identifier 14 is in a different location, area 42 is lowered, and the name 28 is moved above the account number 22. Note that contact plate 110 could, in some instances, be located on side 10 instead. Otherwise, similar items have received a similar number. Note customer service number 62.

Note also that in some instances, lettering and/or numbering on cards may not be embossed, due to possible impact on the appearance of the side of the card opposite the embossing. In some cases, “shadow” type fonts may be used to mimic embossing. Furthermore, in some cases, embossed features may be implemented on a separate substrate 79 and glued to or laminated with the remainder of the card. Laser or thermal imprinting may be employed in some instances. Of course, conventional embossing can be used if desired.

Note that some embodiments may not have a magnetic stripe (by way of example and not limitation, chip cards to be used outside the USA).

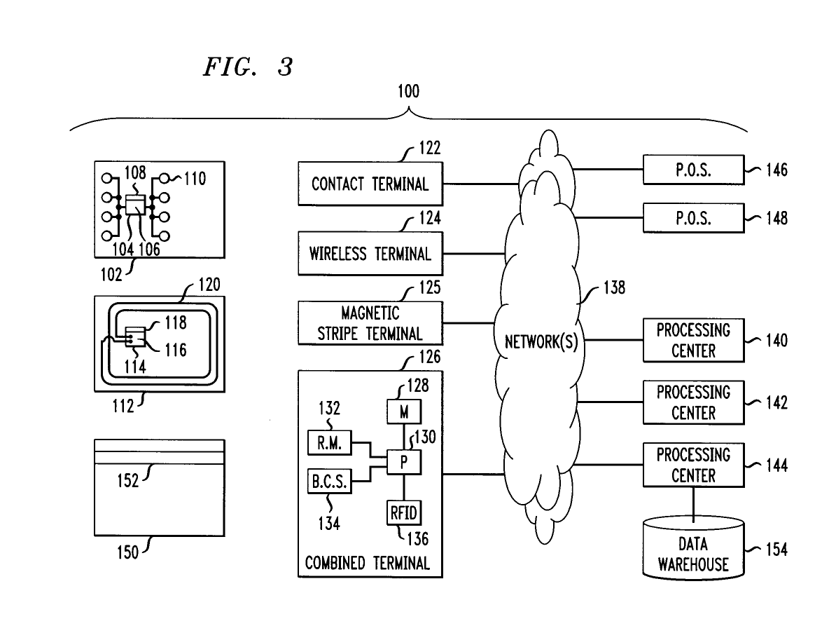

It will thus be appreciated that, in one aspect, an exemplary embodiment of a payment card includes a generally planar body having a first side 10 and a second side 12, and a plurality of acceptance attributes on the second side, wherein the first side is formed without any acceptance attributes thereon. The first side may include artwork of an issuer of the payment card (optionally subject to review and approval by entity 208 or the like). The acceptance attributes may include, for example, one, some, or all of a signature panel 18, a cardholder name 28, a card expiration date 30, and a card security code such as 38. In some cases, the acceptance attributes further comprise at least one of a bar code and a magnetic stripe 16. Where used, the magnetic stripe can, in some cases, be color-coordinated with the second side. The card security code may also be located on a region 40 that is color-coordinated with the second side. In some instances, the first and second sides are color-coordinated. The body portion preferably has a conventional form factor. In some cases, an integrated circuit chip 104, 114 is located within the body portion. As shown in FIGS. 6B and 3, a contact pad 110 can be coupled to the integrated circuit chip and located on one of the first and second sides. As shown in FIG. 3, in some cases, an antenna is coupled to the integrated circuit chip; in such instances, as seen in FIG. 7B, an indicia of contactless operation 78 may be located on the second side.

In another aspect, an exemplary method of using a payment card includes physically presenting, to a merchant, a payment card of the kind described, and viewing by the merchant, of at least needed ones of the acceptance attributes without the merchant being required to turn the card over. Additional steps can include conducting a transaction based on the merchant viewing of needed ones of the acceptance attributes, and/or promoting an issuer of the card by including issuer artwork on the first side of the card.

In still another aspect, another exemplary method of using a payment card includes supplying (without necessarily physically presenting the card), from a card user to a merchant, acceptance attribute information of a payment card of the kind described. The above-described plurality of acceptance attributes include acceptance attribute information (for example, account number and card security code). An additional step includes viewing, by the card user, of the acceptance attribute information without the card user being required to turn the card over. Additional steps can include conducting a transaction based on the supplied acceptance attribute information, and/or promoting an issuer of the card by including issuer artwork on the first side of the card.

Attention should now be given to FIG. 3, which depicts a non-limiting example of a system 100, within which cards according to embodiments of the invention could be used, and/or within which exemplary methods according to embodiments of the invention could be carried out. Various possible components of the system are shown. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Other types of devices could include a card 150 having a magnetic stripe 152.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's personal identification number (“PIN”) and/or primary account number (“PAN”). The memory portions or units 108, 118 can store the operating system of the cards 102, 112. The operating system loads and executes applications and provides file management or other basic card services to the applications. One operating system that can be used is the MULTOS® operating system licensed by MAOSCO Limited. (MAOSCO Limited. St. Andrews House, The Links, Kelvin Close, Birchwood, Warrington, WA3 7PB. United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. Flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that, strictly speaking, the EMV specification defines the behavior of a terminal; however, the card can be configured to conform to such EMV-compliant terminal behavior and in this sense is itself EMV-compliant. It will be appreciated that applications can be configured in a variety of different ways.

As noted, cards 102, 112 are examples of a variety of payment devices. Devices could include cards having a conventional form factor, smaller or larger cards, cards of different shape, key fobs, and the like. The cards can include body portions (e.g., laminated plastic layers of a payment card, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more method steps. The applications can be, for example, application identifiers (AIDs) linked to software code in the form of firmware plus data in a card memory such as an electrically erasable programmable read-only memory (EEPROM). Again, note that “smart” cards are not necessarily required and a conventional magnetic stripe card can be employed.

Note that it is presently believed preferable to employ full-sized cards of a conventional form factor in order to have sufficient space to include the acceptance attributes on a single side.

Cards may conform to the ISO/IEC 7810 ID-1 format for example (also referred to as “full sized” or “conventional form factor”).

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network. More than one network could be employed to connect different elements of the system. Processing centers 140, 142, 144 can include, for example, a host computer of an issuer of a payment device.

Many different retail or other establishments, represented by points-of-sale 146, 148, can be connected to network 138. In one or more instances, various establishments may interface with a telecommunications network, such as a virtual private network (VPN), via one or more machines which are then connected to the network. Each such establishment can have one or more terminals. Further, different types of portable payment devices, terminals, or other elements or components can combine or “mix and match” one or more features depicted on the exemplary devices in FIG. 3.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” cards or mag stripe cards.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128, which then contactlessly transmits the electronic data to the proximity IC chip in the card 112 or other wireless device.

One or more of the processing centers 140, 142, 144 can include a database such as a data warehouse 154.

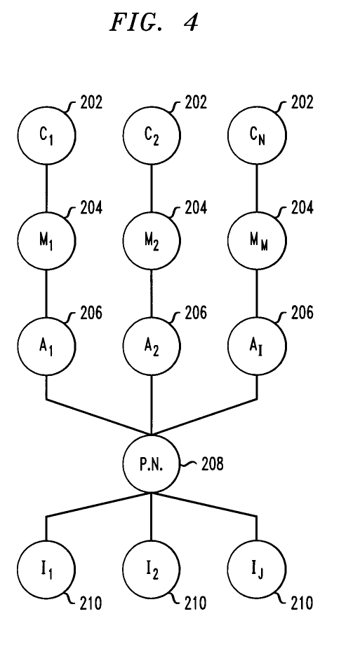

With reference to FIG. 4, an exemplary relationship among multiple entities is depicted. A number of different customers 202, C₁, C₂ . . . C_{N}, interact with a number of different merchants 204, M₁, M₂ . . . M_{M}. Merchants 204 interact with a number of different acquirers 206, A₁, A₂ . . . A₁. Acquirers 206 interact with a number of different issuers 210, I₁, I₂ . . . I_{J}, through a single operator 208 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

In the context of one or more embodiments of the invention, card holder 202 could hold a device such as a payment card in accordance with an embodiment of the invention; merchant 204 could have a terminal such as 122, 124, 125, 126, and the entities 206, 208, 210 could operate processing centers such as 140, 142, 144 (with data storage 154 as needed). Network(s) 138 could, as noted, include a virtual private network (VPN) and/or the Internet; the VPN could be, for example, the aforementioned BANKNET® network, and entity 208 could be, for example, an entity such as MasterCard International Incorporated.

The network 138 can be operated by entity 208 and may employ ISO 8583 messaging, for example.

### System and Article of Manufacture Details

Cards in accordance with embodiments of the invention may be used within larger systems that can employ hardware and/or software aspects. Software includes but is not limited to firmware, resident software, microcode, etc. Software might be employed, for example, in connection with a terminal 122, 124, 125, 126; a processing center 140, 142, 144 (optionally with data warehouse 154) of a merchant, issuer, acquirer, processor, or operator of a network operating according to a payment system standard (and/or specification); and the like. Firmware might be employed, for example, in connection with payment devices such as cards 102, 112.

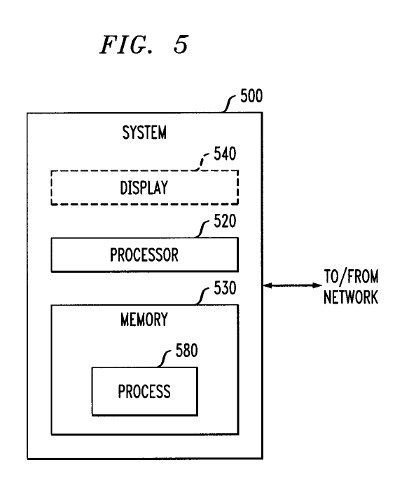

FIG. 5 is a block diagram of a system 500 that can implement part or all of one or more aspects or processes of systems within which cards according to embodiments of the invention can operate or within which methods according to embodiments of the invention can be carried out. As shown in FIG. 5, memory 530 configures the processor 520 to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices (e.g., displays, mice, keyboards, and so on).

As is known in the art, part or all of one or more aspects of methods and apparatuses may be distributed as an article of manufacture that itself comprises a computer readable medium having computer readable code means embodied thereon. The computer readable program code means is operable, in conjunction with a computer system, to carry out all or some of the steps to perform the methods or create the apparatuses. A computer usable medium may be a tangible computer-readable recordable storage medium (e.g., floppy disks, hard drives, compact disks, EEPROMs, or memory cards; not including a transmission medium or disembodied signal) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement methods, steps, and functions. Such methods, steps, and functions can be carried out, e.g., by processing capability on various system elements or by any combination of elements. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of a system can make use of computer technology with appropriate instructions to facilitate method steps. By way of further example, a terminal apparatus 122, 124, 125, 126 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe).

Accordingly, it will be appreciated that one or aspects of a system can include a computer program comprising computer program code means adapted to perform one or steps when such program is run on a computer, and that such program may be embodied on a tangible computer readable recordable storage medium; for example, in the form of distinct software modules which then execute on one or more hardware processors. Further, a system can include a computer comprising code adapted to cause the computer to carry out one or more steps, together with one or more apparatus elements or features.

Computers discussed herein can be interconnected, for example, by one or more of network 138, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic described.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A payment card comprising:
a generally planar body having a first side and a second side; and
a plurality of acceptance attributes on said second side;
wherein said first side is formed without any acceptance attributes thereon.

2. The card of claim 1, wherein said first side includes artwork of an issuer of said payment card.

3. The card of claim 2, wherein said acceptance attributes comprise a signature panel, a cardholder name, a card expiration date, and a card security code.

4. The card of claim 3, wherein said acceptance attributes further comprise at least one of a bar code and a magnetic stripe.

5. The card of claim 3, wherein said acceptance attributes further comprise a magnetic stripe.

6. The card of claim 5, wherein said magnetic stripe is color-coordinated with said second side.

7. The card of claim 5, wherein said card security code is located on a region that is color-coordinated with said second side.

8. The card of claim 5, wherein said card security code is located on a region that is color-coordinated with said second side and said magnetic stripe is color-coordinated with said second side.

9. The card of claim 8, wherein said first and second sides are color-coordinated.

10. The card of claim 1, wherein said body portion has a conventional form factor.

11. The card of claim 1, further comprising an integrated circuit chip located within said body portion.

12. The card of claim 11, further comprising a contact pad coupled to said integrated circuit chip and located on one of said first and second sides.

13. The card of claim 11, further comprising an antenna coupled to said integrated circuit chip.

14. The card of claim 13, further comprising an indicia of contactless operation on said second side.

15. A method of using a payment card, comprising:
physically presenting, to a merchant, a payment card, said card in turn comprising:
a generally planar body having a first side and a second side; and
a plurality of acceptance attributes on said second side;
wherein said first side is formed without any acceptance attributes thereon; and
viewing by said merchant of at least needed ones of said acceptance attributes without said merchant being required to turn said card over.

16. The method of claim 15, further comprising conducting a transaction based on said merchant viewing of needed ones of said acceptance attributes.

17. The method of claim 16, further comprising promoting an issuer of said card by including issuer artwork on said first side of said card.

18. A method of using a payment card, comprising:
supplying, from a card user to a merchant, acceptance attribute information of a payment card, said card in turn comprising:
a generally planar body having a first side and a second side; and
a plurality of acceptance attributes on said second side, said plurality of acceptance attributes including said acceptance attribute information;
wherein said first side is formed without any acceptance attributes thereon; and
viewing by said card user said acceptance attribute information without said card user being required to turn said card over.

19. The method of claim 18, further comprising conducting a transaction based on said supplied acceptance attribute information.

20. The method of claim 19, further comprising promoting an issuer of said card by including issuer artwork on said first side of said card.
